(19) United States
(12) Patent Application Publication
(10) Pub. No.: US 2004/0096288 A1
(43) Pub. Date: May 20, 2004

(54) Method for producing an expansible anchor

(76) Inventors: Willi Haug, Freudenstadt (DE); Walter Saier, Horb-Gruenmettstetten (DE)

Correspondence Address: Striker Striker & Stenby, 103 East Neck Road, Huntington, NY, 11743, US

(21) Appl. No.: 10/472,640

(22) PCT Filed: Mar. 27, 2002
(86) PCT No.: PCT/EP02/03405

(30) Foreign Application Priority Data
Apr. 12, 2001 (DE) 101 18 374.7

(51) Int. Cl. F16B 1/00

(52) U.S. Cl. 411/57.1

(57) ABSTRACT

The invention relates to a method of producing an expansible anchor having, at its front end, a cone (5), provided with a low-friction coating, for expansion of a slit expansion sleeve (6) and having, on its rear end, a thread (2) for fastening an article to a building component. In order to improve adhesion of the low-friction layer to the cone (5) and to prevent damage to the low-friction layer during expansion, the surface of the cone (5) is so treated with steel brushes before the low-friction coating is applied that a score structure (11) is produced.

The invention relates to a method of producing an expansible anchor having, on its front end, a cone, provided with a low-friction coating, for expanding a slit expansion sleeve and having, on its rear end, a thread for fastening an article to a building component.

An expansible anchor of that kind is known from EP 0 514 342 B1. In order to achieve reliable behaviour of subsequent expansion in a cracked tension zone, there is arranged on the outer contour of the expansion sleeve at least one pair of protrusions located one behind the other in the longitudinal direction and the cone of the expansible anchor is provided with a friction-lowering coating. Before the low-friction coating is applied, the bolts, which are produced by turning or cold-forming, are cleaned in a pickling procedure, wherein it is not always possible to prevent oil residues remaining on the bolt. Such oil residues impair adhesion of the low-friction coating to the bolt, leading to impairment in the function of subsequent expansion behaviour. In addition, sharp edges on the expansion sleeve can damage the low-friction layer, at least in places, when the expansion sleeve slides up onto the expansion cone.

The invention is based on the problem of so improving the method of producing an expansible anchor having a coated cone that, on the one hand, better adhesion of the low-friction coating is achieved and, on the other hand, damage to the low-friction coating is avoided.

The problem is solved in accordance with the invention by the features of claim 1. After the pickling procedure for removal of production residues, the cone is so treated in an apparatus having rotating steel brushes that there is produced a structure of scores oriented at an angle to the axial direction of the expansible anchor. By using steel brushes for the treatment, the expansion cone is entirely cleaned of oil residues and, at the same time, the score structure is produced, which brings about good adhesion of the low-friction coating to the expansion cone. In addition, the structure of scores, oriented preferably at an angle of 45°, ensures that the expansion sleeve slides only on the raised regions when the cone is being drawn into it. As a result, the low-friction coating is prevented from being scraped off and a more uniform sliding behaviour is achieved.

Low-friction coatings for ensuring subsequent expansion behaviour in the cracked tension zone are necessary especially in the case of expansible anchors made from stainless steel because under high pressure, when the expansion sleeve is being slid up onto the cone, such anchors especially have a tendency to cold-welding. For treating expansible anchors made from stainless steel it is advantageous to use brushes having stainless steel bristles, which prevents material abraded from the brushes during the treatment, in the form of particles of rust, from sticking to the surface of the expansible anchor.

The method according to the invention is especially suitable for producing an expansible anchor made from stainless steel having, on its rear portion, a thread and, having, in the front region, a portion of reduced diameter, which is adjacent to a cone, provided with a low-friction coating, for expansion of an expansion sleeve having protrusions on its external contour. By virtue of the score structure oriented at an angle to the axial direction of the expansible anchor, damage to the low-friction coating is prevented especially during expansion of the expansible anchor so that reliable subsequent expansion behaviour is ensured in the cracked tension zone. A score structure having a surface roughness depth of from 10 μm to 20 μm has been found to be especially advantageous.

The invention is described hereinafter with reference to an exemplary embodiment,

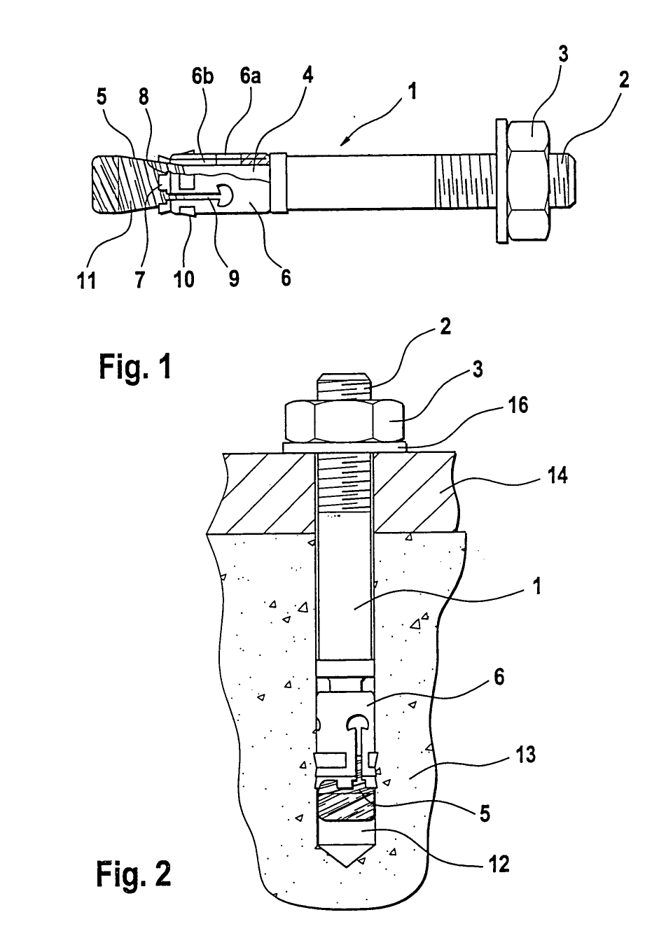

FIG. 1 being a view showing the expansible anchor according to the invention; and

FIG. 2 showing the expansible anchor of FIG. 1 anchored in a building component.

FIG. 1 shows the expansible anchor having a bolt shank 1, which has, on its rear portion, a thread 2 together with a screwed-on nut 3 and, in the front region, a portion 4 of reduced diameter, which is adjacent to a cone 5. Arranged on the portion 4 of reduced diameter is an expansion sleeve 6 produced from a thin metal sheet in a bending and stamping tool. As a result of folding-over, a double sleeve is produced, having an outer sleeve 6a and an inner sleeve 6b, the inner sleeve 6b projecting further at the end face than the outer sleeve 6a. This projection 7 is indented as a result of rectangular cut-outs 8. For expansion of the expansion sleeve 6, the latter has a plurality of slits 9 and, for fixing in the drilled hole, it has protrusions 10 on its external contour.

In order, on the one hand, to achieve better adhesion of the low-friction coating of the cone and, on the other hand, to prevent damage to the low-friction layer when the expansion sleeve slides onto the cone, the expansion cone 5 is provided with a score structure 11 oriented preferably at an angle of 45° to the axial direction of the expansible anchor. The score structure 11 preferably has a surface roughness depth of 10-20 μm. The score structure 11 on the expansion cone 5 is applied before the low-friction coating, using rotating steel brushes. In the case of an expansible anchor made from stainless steel, brushes having stainless steel bristles are used in order to avoid corrosion on the surface of the cone caused by material abraded from the steel brushes which sticks to the cone.

After treatment of the cone 5 with steel brushes, coating is carried out preferably using a resin system based on an epoxy resin, to which a solid lubricant such as, for example, graphite may also be added.

FIG. 2 shows the expansible anchor anchored in a hole 12 drilled in a building component 13 and the fastening of an article 14 to the building component 13. For installation of the expansible anchor, it is pushed through the hole 15 drilled in the article 14 being fastened and into the hole 12 drilled in the building component 13 until the washer 16 and nut 3 come up against the article 14. Screwing-up of the nut 3 causes the bolt shank 1 to move in the direction of the mouth of the drilled hole, whereupon the expansion cone 5 is drawn into the expansion sleeve 6, which is fixed immovably in the drilled hole 12. When the cone 5 is drawn in, the expansion sleeve 6 is expanded and, as a result, the expansible anchor is anchored in the drilled hole. If, at some later point in time, the drilled hole widens as a result of crack formation, the tensile load acting on the bolt shank 1 causes the cone 5 to slide further into the expansion sleeve 6 and, as a result, causes the subsequent expansion of the expansible anchor.

1. Method of producing an expansible anchor having, at its front end, a cone (5), provided with a low-friction coating, for expansion of a slit expansion sleeve (6) and having, on its rear end, a thread (2) for fastening an article to a building component, characterised in that, before application of the low-friction coating, the surface of the cone (5) is so treated with steel brushes that a score structure (11) having scores oriented in parallel are formed.

2. Method according to claim 1, characterised in that the score structure (11) is oriented at an angle of preferably 45° to the axial direction of the expansible anchor.

3. Method according to claim 1, characterised in that brushes having stainless steel bristles are used for the treatment.

4. Expansible anchor made from stainless steel having, on its rear portion, a thread (2) and having, in the front region, a portion (4) of reduced diameter, which is adjacent to a cone (5), provided with a low-friction coating, for expansion of an expansion sleeve (6) having protrusions (10) on its external contour, characterised in that the cone (5) has a score structure (11) oriented at an angle to the axial direction of the expansible anchor.

5. Expansible anchor according to claim 4, characterised in that the score structure (11) has a surface roughness depth of 10-20 μm.
